(19) United States
(12) Patent Application Publication
(10) Pub. No.: US 2025/0386160 A1
(43) Pub. Date: Dec. 18, 2025

(54) OPTIMIZATION OF AUDIO SYSTEM CHARACTERISTICS IN ROOM ENVIRONMENTS

(71) Applicant: QSC, LLC, Costa Mesa, CA (US)

(72) Inventors: Alfredo Martin Aguilar Caamal, Chula Vista, CA (US); Mitchell Walker, Arvada, CO (US)

(21) Appl. No.: 19/236,024

(22) Filed: Jun. 12, 2025

Related U.S. Application Data
(60) Provisional application No. 63/658,953, filed on Jun. 12, 2024.

(51) Int. Cl. H04S 7/00; G10L 15/16

(52) U.S. Cl. CPC H04S 7/301; G10L 15/16; H04S 7/40; H04S 2400/15

(57) ABSTRACT

A system allows users to automate optimization of audio system characteristics using voice activity detection. The system utilizes trained learning models that enable measurement of noise levels while actively excluding speech or other noise interfering with measurement of acoustical characteristics of an external environment, such as a meeting room. Further, the system tracks noise levels during meetings and after meetings to provide accurate representations of the meeting room environment—while not requiring a quiet testing environment. Reports may be generated by the system to track noise activity continuously over long periods of time.

### PRIORITY

The present application is a non-provisional of and claims priority to U.S. Provisional Patent Application No. 63/658,953, filed on Jun. 12, 2024, entitled “Optimization of Audio System Characteristics In Room Environments,” having the same inventorship, the disclosure of which is hereby incorporated by reference in its entirety.

### FIELD OF THE INVENTION

The present disclosure is generally related, but not limited, to audio processing optimization and, more specifically, to methods and systems using voice activity detection and speech signal-to-noise ratios (“SNR”) to measure room acoustics for audio-processing optimization.

### BACKGROUND

The acoustics of meeting room environments are often sub-par, thus requiring measurement and optimization. However, current acoustic measurement tools require a technician/installer to take noise measurements while no one is talking. If someone happens to talk during the measurement (or other disturbance of ambient noise), the measurement process needs to be repeated by the technician. Thus, this need for human intervention makes such systems inefficient, more costly and difficult to use.

### BRIEF DESCRIPTION OF THE DRAWINGS

FIG. 1 is a block diagram of an optimization and control system according to certain illustrative embodiments of the present disclosure.

FIG. 2 is a block diagram of the audio optimization processing flow, according to certain illustrative embodiments of the present disclosure.

FIG. 3 is a flow chart of a method to optimize audio system characteristics in a meeting room through the use of digital signal processing, according to certain illustrative embodiments of the present disclosure.

FIG. 4 is a view of an illustrative room health report generated by the optimization systems of the present disclosure.

FIG. 5 illustrates an alternative comprehensive signal flow of audio (and AI) algorithms used to determine the speech SNR, according to illustrative embodiments of the present disclosure.

FIG. 6 is a flow chart providing a more detailed view of a method for determining the speech SNR, according to certain illustrative embodiments of the present disclosure.

FIG. 7 is a flow chart for a generalized method to optimize audio system characteristics in a meeting room environment through use of digital signal processing, according to certain illustrative embodiments of the present disclosure.

FIG. 8 is a flow chart of a method to obtain room noise measurements using the audio optimization techniques described herein.

FIG. 9 is a flow chart of a method to obtain room reverberation measurements using an illustrative VAD module of the present disclosure.

FIG. 10 is a flow chart of a method to optimize a microphone level using the method of FIG. 6.

FIG. 11 is a flow chart of a method to optimize a speaker level using the method of FIG. 6.

FIG. 12 is a flow chart of a method to optimize a microphone frequency response using the method of FIG. 6.

FIG. 13 is a flow chart of a method to optimize a speaker frequency response using the method of FIG. 6.

### DESCRIPTION OF ILLUSTRATIVE EMBODIMENTS

Illustrative embodiments and related methods of the present disclosure are described below as they might be employed to optimize audio system characteristics in a room through use of signal processing techniques using voice activity detection and speech SNR calculations. The embodiments provide a solution that measures noise levels in an environment even when someone inadvertently speaks (or other disturbances in ambient noise occur) during the measurement. The systems recognize the speech segment and actively remove it from the measurement. Additionally, the embodiments of the system may continuously monitor, without human intervention, the health of the meeting room (or other environment) for periods of time, even when the room is active in a meeting session.

In the interest of clarity, not all features of an actual implementation or methodology are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

More specifically, illustrative embodiments of the present disclosure allow users to automate meeting room acoustic optimization using voice activity detection. The embodiments described herein use a human-to-machine voice activity detector (“VAD”) based system designed to improve measurement of ambient noise levels in meeting rooms, thereby making room-health reporting easier and more comprehensive. The system uses trained learning models that enable measurement of noise levels while actively excluding speech or other noise interfering with measurement of acoustical characteristics of an external environment, such as a meeting room. Further, other aspects of the system track noise levels during meetings and after meetings to provide accurate representations of the meeting room environment—while not requiring a quiet testing environment. Reports may be generated by the system to track noise activity continuously over long periods of time (e.g., days, weeks, months, etc.), thus identifying periodic or seasonal noise activity bolstering a more accurate representation of the room environment.

Voice activity detection (VAD), also known as speech activity detection or speech detection, is the detection of the presence or absence of human speech, used in speech processing. Such techniques may or may not include artificial intelligence-based algorithms, as will be understood by those ordinarily skilled in the art having the benefit of this disclosure. As described herein, embodiments of the present disclosure seamlessly and actively monitor room noise health during or not during meetings to determine room noise health, such as identification of rooms which are noisier than typical rooms (and the root causes thereof). As a result, embodiments of the present disclosure enable fast adaptation time, thus providing measurement of noise between speech activity (i.e., ambient noise) of the participants in the meeting room.

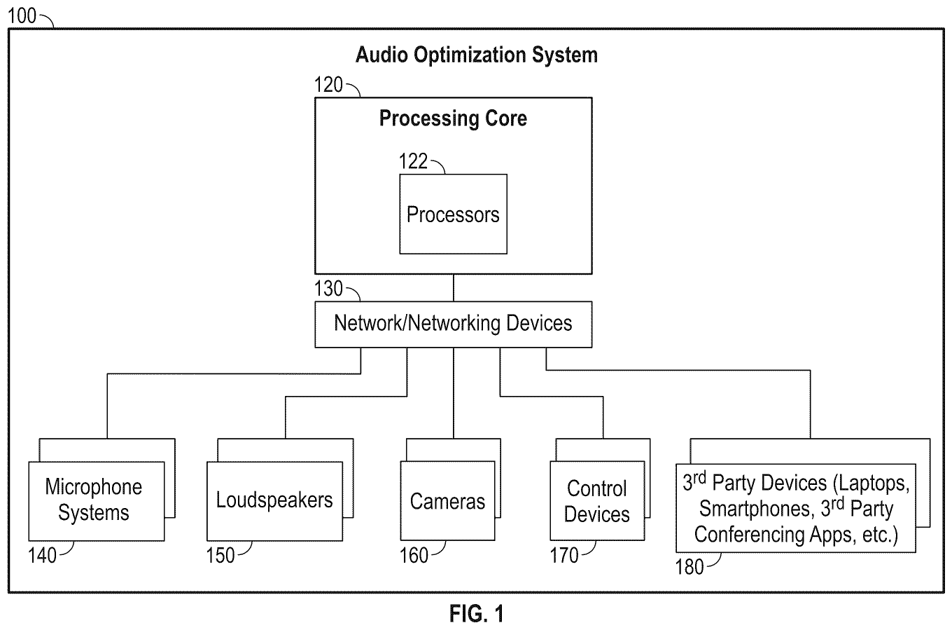

FIG. 1 is a block diagram of an optimization and control system according to certain illustrative embodiments of the present disclosure. Audio processing systems typically include sophisticated computer-controlled equipment that receives and distributes sound in a space. Such equipment can be used in business establishments, bars, restaurants, conference rooms, concert halls, churches, meeting rooms, or any other environment where it is desired to receive audio inputs from a source and deliver it to one or more speakers for people to hear. Some modern systems incorporate integrated audio, video, and control capability to provide an integrated system architecture. An example of such a system is the QSC® Q-SYS™ Ecosystem provided by QSC, LLC, the applicant of the present disclosure, which provides a scalable software-based platform.

In this example, system 100 includes a processing core 120 that includes one or more processors 122, a network 130, one or more microphone systems 140, loudspeakers 150, cameras 160, control devices 170, and third party devices 180. The processor(s) 122 of the illustrated embodiment may include general purpose microprocessors, as well as one or more processor(s) to perform the voice activity detection and speech SNR calculations of the present disclosure, although alternative configurations can include an audio processor designed for audio digital signal processing.

The microphone systems 140 can include one or more microphone array systems, which can be any suitable microphone array system including microphones mounted in an asymmetric array, although other types of microphone systems can also be included. Microphone systems 140 can also include, for example, ceiling or table top microphones, as well as beam forming microphones. The cameras 160 can include one or more digital video cameras. The control devices 170 can include any appropriate user input devices such as a touch screen, computer terminal, or the like. While not shown in FIG. 1, the system 100 can also include appropriate supporting componentry, such as one or more audio amplifiers or equalization components.

The third-party devices 180 can include one or more laptops, desktops or other computers, smartphones or other mobile devices, projectors, screens, lights, curtains/shades, fans, and third-party applications that can execute on such devices, including third party conferencing applications such as Zoom or Microsoft® Teams, or digital voice assistants like Apple's Siri®.

While illustrated as separate components in FIG. 1, depending on the implementation, microphone systems 140, loudspeakers 150, cameras 160, control devices 170, and/or third-party devices 180 can be integrated together. For example, some or all of a microphone array, loudspeaker, camera, and touch screen can be integrated into a common packaging.

In operation, the microphone(s) 140 detect sounds in the environment, convert the sounds to digital audio signals, and stream the audio signals to the processing core 120 over the network 130. The processor(s) 122 receives the audio signals and performs digital signal processing on the signals, as described herein. For example, the processor 122 can perform fixed or adaptive echo cancellation, fixed or adaptive beamforming to enhance signals from one or more directions while suppressing noise and interference from other directions, amplification, or any combination thereof. Other types of noise processing, spatial filtering, or other audio processing can be performed depending on the embodiment. In some embodiments, instead of the microphone 140 sending raw digital audio signals to the processing core 120, one or more processors on the microphone system 140 itself performs some or all of the echo cancellation, beamforming, amplification, or other processing prior to sending the signal to the processing core 120.

As mentioned, the microphone system 140 can include one or more microphone arrays including a plurality of individual microphone elements. As these microphone arrays become more feature-rich, they include increasing numbers of not only microphone elements but other components (processors, sensors, electrical components, etc.). However, existing microphone arrays such as those used for beamforming typically employ microphones arranged in rigidly defined geometries. These can include concentric rings, straight lines, squares, rectangles, or the like.

The illustrative audio optimization system 100 described herein has a variety of use cases. First, for example, the system is particularly useful for technicians during installation before a meeting begins. An installation technician in meeting rooms frequently does not have control over the people in the environment who may inadvertently speak while a room noise measurement is being conducted. Additionally, the measurement may not properly capture noise situations in the meeting room; for example, the heater or AC (HVAC) may not be active when the measurement is taken. Because the presently disclosed systems are contextually aware of the noise environment, the systems offer technicians a simpler approach, requiring no human intervention when noise measurements are taken. Additionally, the system can run continuously for periods of time to capture events (e.g., heater, AC, etc. turning on/off) that typically happen in the meeting room.

Second, the system is applicable for audio optimization during a meeting session. Meeting room health is very critical when the room is active with meeting participants. Because of this, knowing the noise levels during a meeting session is more important than during meeting installation or outside of normal operating hours. Noise activity increases when participants are present in room; for example, chairs or table could be squeaky and the resulting noises could significantly distract meeting flow and discussion. Technical aspects of the presently disclosed systems seamlessly and actively monitor room noise health during meetings and help identify rooms (and root causes) which are noticeably noisier than typical rooms. Because of its fast adaptation time, the system measures noise between speech activity, of participants, in meeting rooms.

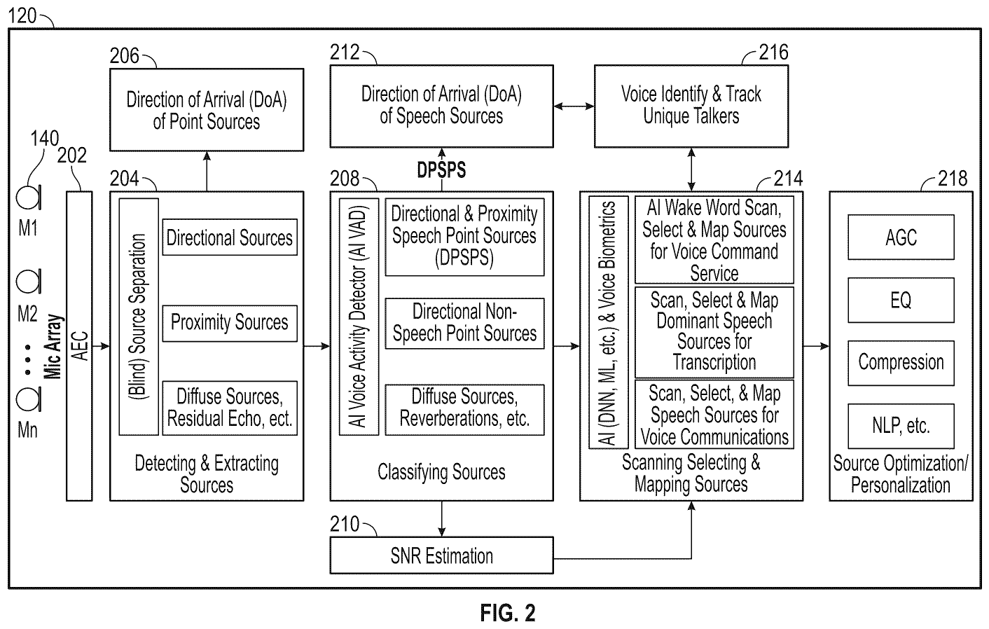

FIG. 2 is a block diagram of the audio optimization processing flow, according to certain illustrative embodiments of the present disclosure. The use of artificial intelligence (“AI”) and other tool enhancements in certain embodiments described herein provide the ability to measure and optimize audio in the presence of interfering signals (e.g., speech). The addition of algorithms such as, for example, VAD and speech SNR calculation allow the systems described herein to operate under these otherwise adverse conditions and still successfully provide accurate and more precise measurements and optimizations.

FIG. 2 illustrates an illustrative signal flow describing a collection of audio algorithms, some AI-based or driven, that system 100 will utilize to perform the methods described herein. The block diagram of FIG. 2 shows how system 100 receives audio signal inputs from microphone array 140, passes those signals through an acoustic echo canceller 202, and into a collection of audio algorithms (as described below) to detect and extract audio sources, classify those sources, and then perform scanning, selecting, and mapping of those sources, leading to digital signal processing (DSP) algorithms for source optimization and presentation, as described herein.

In the illustrated example, the echo cancelled audio signals are first passed to a source separation module 204 to detect and extract sources of the audio signals. Here, these audio algorithms are focused around source separation, which splits sources to be processed in different ways later in the chain depending on the sources identified, and generates direction of arrival information to know where sources are coming from in the acoustic environment. The functionality of source separation module 204 involves blind source separation, as well as the identification of directional sources, proximity sources, diffuse sources and residual echo-all to ultimately determine the direction of arrival of point sources at block 206.

Next, the audio signals are processed by VAD module 208 which performs the voice activity detection used to classify audio sources. Here, processing core 120 determines if human speech is present in the audio signals. In this example, VAD module 208 includes artificial intelligence functionality. However, in other embodiments, artificial intelligence capability may not be employed. Nevertheless, VAD module 208 determines the directionality and proximity of speech point sources, non-speech point sources, diffuse sources and reverberations, at block 212. With this data, and source separation, the speech SNR of the signal being processed can be determined at block 210, qualifying the speech intelligibility, and determining how noisy or speech-filled the audio signals are.

Next, voice biometrics module 214 is used for identifying and tracking unique talkers, which can be used to distinguish important audio from uninteresting signals, as well as quantifying and qualifying the audio from sources of interest. These voice biometrics also have application towards some AI automation tools like wake words, voice commands to audio-based control systems, and speech transcription. Thus, voice biometrics module 214 performs functions such as, for example, AI wake word scanning, selecting and mapping of sources for voice command service; scanning, selecting, and mapping of dominant speech sources for transcription; and scanning, selecting, and mapping speech sources for voice communications-ultimately to identify voices and track unique talkers within the room environment at block 216.

In certain illustrative embodiments, over time, the system may build individual voice profiles for meeting participants. For example, if a specific user consistently speaks at a lower volume, the system may automatically increase gain or adjust other equalization (EQ) parameters for that user based on their biometrics.

Using this data provided by the above-described modules, optimization system 100 then adjusts and optimizes the audio sources (e.g., mics 140, loudspeakers 150, and so on) at block 218. Such optimization may be in the form of EQ, audio compression, automatic gain control and natural language processing, and so on. For example, some ASR engines (i.e., Cortana, etc.) are optimized for a specific speech level; if the average RMS level, for some speech signal (at block 218) is −32 dBFS and the optimal level required by the ASR engine is, for example, −21 dBFS then AGC (in 218 block) would bring the speech level closer to target of −21 dBFS (from −32 dBFS). In other examples, optimization may further consider real-time inputs form environmental sensors (e.g., occupancy sensors, thermal imaging sensors) to inform dynamic changes in EQ (e.g., gain or filtering) based on room usage patterns or participant density.

Moreover, in other illustrative embodiments, the system can also classify audio source types using AI-driven audio classifiers, thus enabling dynamic filtering EQ customized for each audio source type. The audio source types can be, for example, HVAC hum, keyboard typing, outdoor machinery, etc.

Ultimately, FIG. 2 illustrates a comprehensive signal flow of audio (and AI related) algorithms that produce information of value for optimization system 100. As shown, system 100 uses the source separation to measure sources of relevant types (noise signals for noise measurement tests for example). System 100 uses the VAD and SNR estimation to understand when adverse conditions are present, and with the source separation, ignore sources not desired in the audio mix and focus on the sources system 100 intends to measure (intrusive speech or noise versus the system's 100 own test signals). Further, voice biometrics and profiling augment this ability by allowing system 100 to profile its own test signals. In turn, audio DSP algorithms can work in conjunction with system 100 and use any profiling data in the system to know if audio signals going through processing come from sources that would benefit from more personalized optimization (e.g., a person whose profile indicates they are a quiet talker and would benefit from extra gain).

Thus, through use of VAD module 208, optimization system 100 provides improved understanding when interfering speech is present, instead of just estimating for anomalous interference. With source separation module 204, SNR estimation 210, and VAD module 208, optimization system 100 can operate even with interfering speech. With voice biometrics module 214 added, optimization system 100 provides increased optimization capability to operate under even more adverse conditions.

In certain other illustrative embodiments, video may be used to further optimize audio characteristics of the room environment. For example, the system may also utilize lip movement analysis via in-room video (e.g., using cameras 160) to enhance the accuracy of VAD module 208. Such a feature is useful especially in noisy environments or when multiple participants are present. In other examples, during meetings, if a participant is seated near speaker A (determined via video signals received from cameras 160), the system dynamically reduces speaker A output to reduce discomfort, while increasing output of speaker A when video reflects participants are far away. In like manner, video signals from cameras 160 may be used to inform placement of microphones in the room environment.

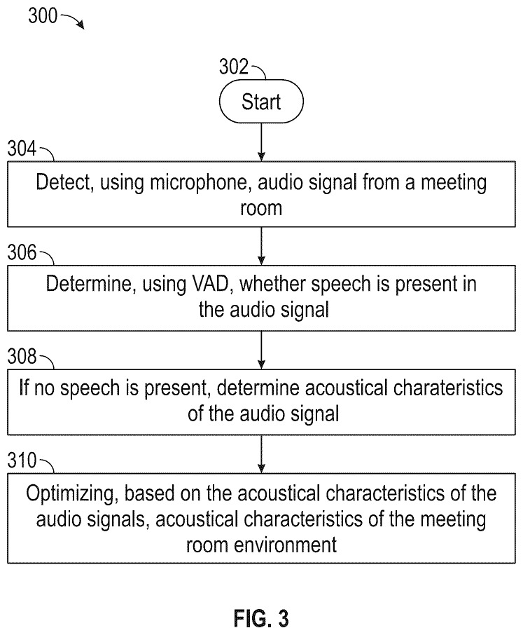

FIG. 3 is a flow chart of a method to optimize audio system characteristics in a meeting room through the use of digital signal processing, according to certain illustrative embodiments of the present disclosure. At block 302, optimization system 100 begins by implementing an audio optimization and control (“AOC”) operating system on a processing device communicably coupled to at least one microphone and at least one speaker located within the meeting room. As described herein, the processing device is configured to optimize and control audio functionality of the microphone and speaker. At block 304, the processing device detects, using the microphone, one or more audio signals from the meeting room. Here, source separation module 204 is used to detect and extract the audio signal sources and determine the directionality of the sources.

At block 306, the processing device determines, using a VAD communicably coupled to the processing device, whether speech is present in the audio signals. In certain embodiments, the determination is made using a VAD communicably coupled to the processing device. As previously described, here system 100 utilizes the VAD module 208 to determine the presence and directionality of speech point sources, diffuse sources, reverberations, etc.-all used to classify the audio signal(s) as including speech or not including speech. In alternative embodiments, the technician simply makes sure no persons are speaking or other ambient sounds are present during the tuning/optimization process.

At block 308, once the processing device determines no speech is present in the audio signals, the processing device determines the acoustical characteristics of the audio signals. The acoustical characteristics of the room may be, for example, a room noise measurement or room reverberation measurement.

At block 310, the processing device then optimizes, based on the acoustical characteristics of the audio signals, the audio system characteristics of the meeting room environment. Thus, using the room noise or reverberation measurement, the audio system characteristics of the meeting room are optimized by, for example, optimizing the microphone levels in the room, optimizing the speaker levels in the room, optimizing the frequency response of the microphones in the room or optimizing the frequency response of the speakers in the room.

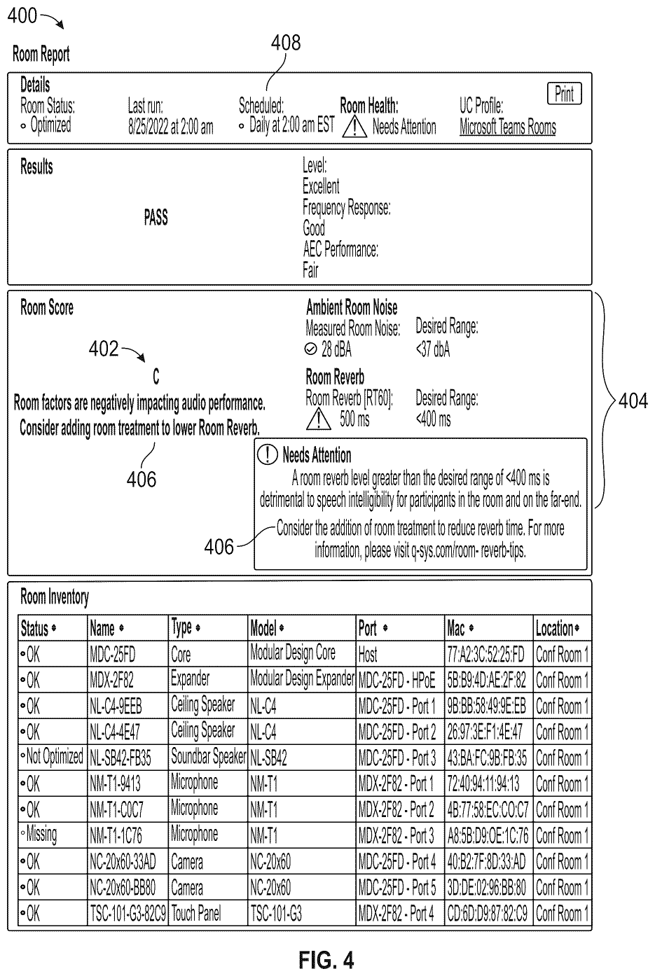

In yet further illustrative embodiments of the present disclosure, audio optimization system 100 can further generate a report of the acoustical characteristics of the meeting room environment. The report may include a variety of information such as, for example, a room health score, room characteristic alert or acoustic-improvement recommendation. FIG. 4 is a view of an illustrative report 400 generated by optimization system 100. In this report, a room health score 402, room characteristics alert 404, and acoustic-improvement recommendation 406.

Further, audio optimization system 100 continuously monitors the meeting room environment and performs the optimization process without the need for human intervention. For example, optimization system 100 can be set to perform the optimization process on a desired schedule. As seen in report 400, optimization system 100 has been set to perform optimization daily at a 2:00 am EST run time (schedule 408). Further, optimization system 100 can monitor the room acoustics and perform optimizations while a meeting is occurring or at some other time.

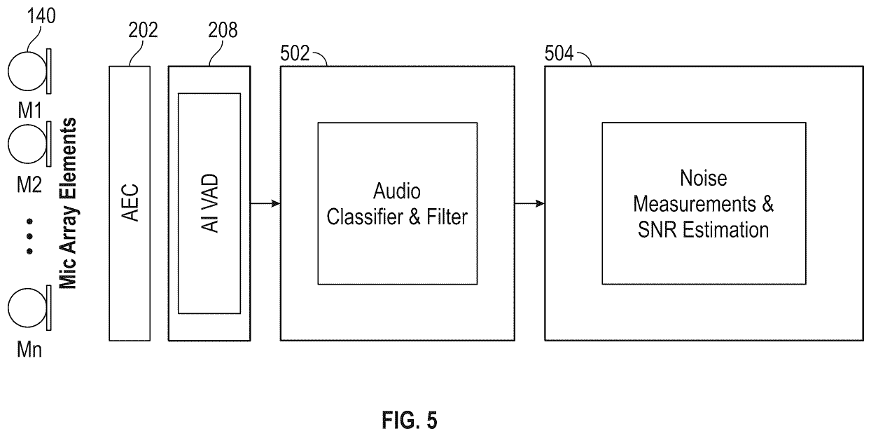

As previously described in relation to FIG. 2, the illustrative embodiments of the present disclosure also utilize the speech SNR of the audio signal to enhance optimization of the audio system characteristics in the room environment. FIG. 5 illustrates an alternative comprehensive signal flow of audio (and AI) algorithms used to determine the speech SNR, according to illustrative embodiments of the present disclosure. Here, again, optimization system 100 obtains one or more audio signals from one or more microphones 140. The audio signals are then echo cancelled at acoustic echo cancellation (AEC) block 202. Thereafter, the echo cancelled audio signals are fed to an AI VAD module 208 to detect the presence of speech in the audio signals. At block 502, the optimization system then classifies the audio signals into one or more audio segments based, in part, on the presence of speech, as described in more detail below. Once the speech and noise has been isolated by optimization system 100, the speech SNR is then determined at block 504. Using the speech SNR, the room environment is optimized.

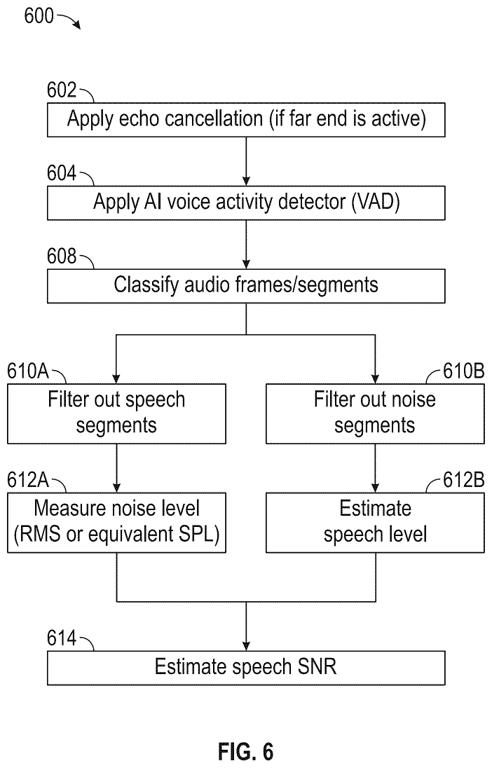

FIG. 6 is a flow chart providing a more detailed view of the method for determining the speech SNR, according to certain illustrative embodiments of the present disclosure. At block 602 of method 600, the audio signal(s) received by optimization system 100 are echo cancelled. In this example, the echo cancellation is applied if the far end (e.g., the location of other participants on a videoconferencing meeting) is active, for example, to remove any acoustic echo from speakers outputting audio signals caused by active talkers on the far end. At block 604, an AI VAD module is used to detect speech in the audio signals and, thereafter, at block 608, the system classifies the audio frames/segments accordingly. In this example, the audio segments are classified as being a speech only segment, noise only segment or speech-with-noise segment.

At block 610A, optimization system 100 filters out the speech segments (leaving only noise) in order to measure the noise level at block 612A. The noise level may be, for example, measured using RMS (root mean square) or equivalent SPL (sound pressure level). At block 610B, optimization system 100 filters out the noise segments (leaving speech only) and determines the speech level at block 612B. At block 614, optimization system 100 then determines the speech SNR using the filtered audio segments.

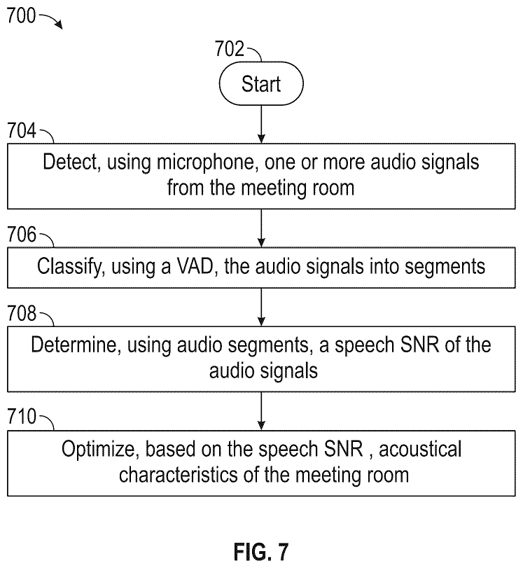

In view of the foregoing, FIG. 7 is a flow chart for a generalized method to optimize audio system characteristics in a meeting room environment using digital signal processing, according to certain illustrative embodiments of the present disclosure. At block 702 of method 700, optimization system 100 begins by implementing an AOC operating system on a processing device communicably coupled to at least one microphone and at least one speaker located within the meeting room. The processing device is configured to optimize and control audio functionality of the microphone and speaker. At block 704, optimization system 100 detects, using the microphone, one or more audio signals from the meeting room. At block 706, optimization system 100 uses a VAD to classify the audio signals into one or more audio segments. These speech segments may be classified into speech-only segments, noise-only segments, or speech-with-noise segments. At block 708, optimization system 100 determines, using the audio segments, a speech SNR of the audio signals. Method 600 is one example of a method to determine the speech SNR.

At block 710, optimization system 100 then optimizes, based on the speech SNR of the audio signals, the audio system characteristics of the meeting room environment. The audio system characteristics of the meeting room can be optimized by optimizing the overall microphone conferencing level within a band of acceptability, the overall speaker playback level within a band of acceptability, overall microphone conferencing frequency response with a band of acceptability, overall speaker playback frequency response within a band of acceptability.

The speech SNR can be utilized to enhance optimization in a number of ways. For example, as shown in FIG. 2, the speech SNR is used by voice biometric module 214 to perform scanning, selecting and mapping of speech sources, as previously described.

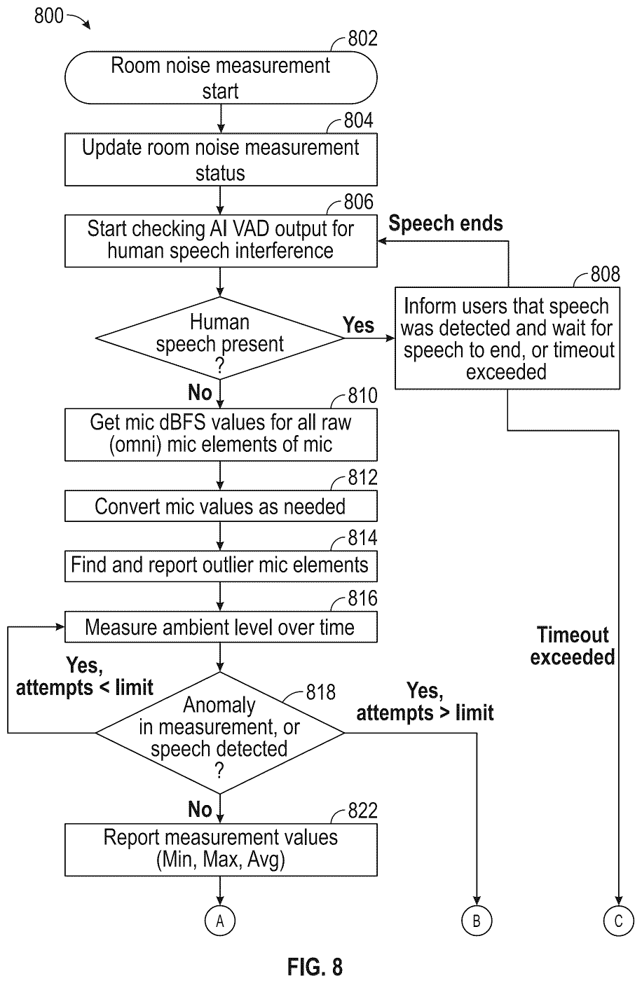

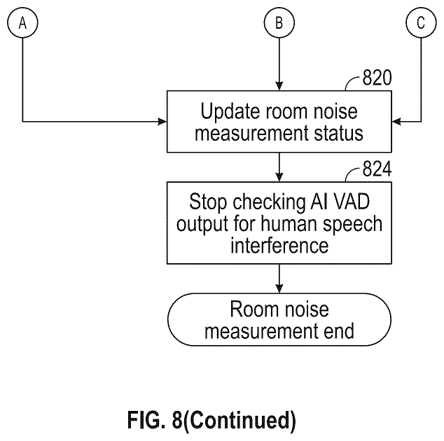

The audio system optimization methods described herein can be applied in a variety of ways. For example, the audio optimization methods may be used to acquire room noise measurements. FIG. 8 is a flow chart of a method to obtain room noise measurements using the audio optimization techniques described herein. In method 800, the system begins at block 802 and updates the room noise measurement status at block 804. Here, the noise measurement status can be, for example, “not optimized” when initialized, “running” when running, “reading anomaly” when there is an anomaly or issue during the measurement, “done” if the measurement completed successfully, and various grades of warning or failure if measured values are outside the desirable ranges and limits. At block 806, the system begins checking the output of a VAD module for human speech interference. If human speech is present, the system informs the user (e.g., via some user interface, etc.) speech was detected. In this example, the system will wait for the speech to end or until some defined timeout is exceed, at block 808. The system will then iteratively continue checking for the presence of speech until no speech is present. Once no speech is present, the system obtains microphone dBFS values for all raw microphone elements, at block 810.

In alternative methods, block 806 is not used (AI VAD is not used). In such embodiments, instead the technician simply makes sure no persons present in the room are speaking during the optimization process. Thus, blocks 806 and 808 would not be utilized in this alternative method (which is why blocks 806 and 808 are denoted as dotted lines).

At block 812, the system converts the microphone values as needed. In certain examples, the relevant ways of reading the microphone values are as dBFS (decibels full scale, measured with respect to full scale of the DSP system) and dBSPL, or dBSPL-A (decibels sound pressure level, unweighted or A weighted). Converting between the values is done with pre-knowledge of the microphone's known sensitivity value, which gives a mapping of dBFS, which is measured within the QSYS system, and dBSPL/dBSPL-A which is meaningful and useful to users comparing the level to real world noises.

At block 814, the system finds and reports outlier microphone elements. In certain examples, outlier microphone elements are found and reported by analyzing the measured values from each mic element connected to the system, finding the mean and the mode values, and outliers are identified as being both uncommon values in the set, and deviated from the average by more than manufacturing tolerance would allow.

At block 816, using the microphone elements, the system will measure ambient noise in the room over a defined time period. Here, the system may employ method 600 to measure the noise level, estimated speech level, calculated SNR, etc. as informative values for its measurements. At block 818, the system determines if there are any anomalies in the audio measurements or if speech is detected. Again, here, a VAD module may be used. If speech or an anomaly is detected (or timed out), the system will update the room noise measurement status at block 820. If the anomaly or speech is not detected, the system will then report the noise measurement values (e.g., min, max, avg), at block 822. At block 824, the system then stops checking the VAD module output and the room noise measurement process ends. Note, in those methods in which the VAD module is not being used (human technician makes sure no speech is present), block 824 is skipped.

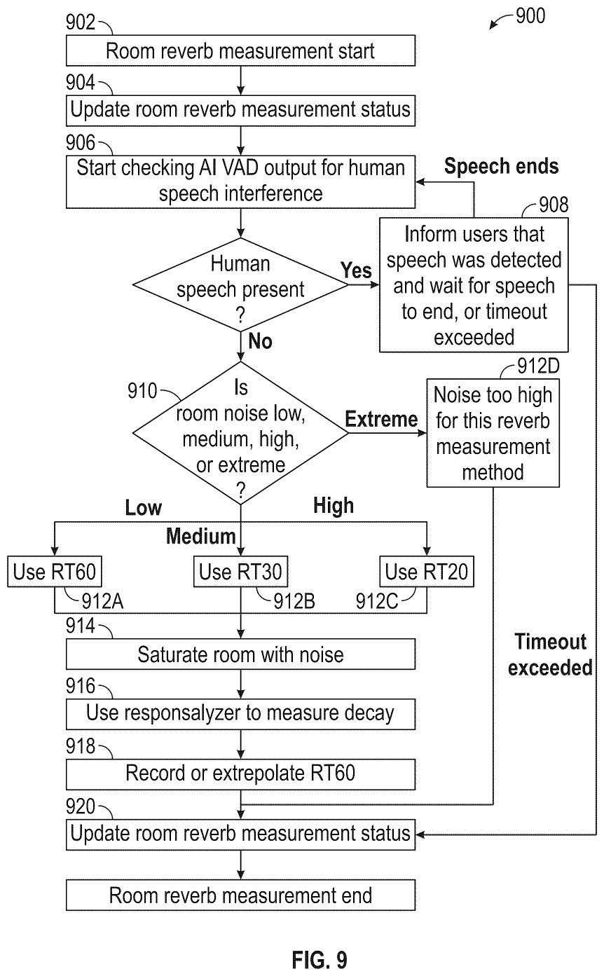

The audio optimization methods may also be used to acquire room reverberation measurements. FIG. 9 is a flow chart of a method to obtain room reverberation measurements using a VAD module. At block 902 of method 900, the system starts up and updates the room reverberation measurement status at block 904. The reverberation measurement status is similar to that of the room noise status previously discussed. At block 906, the system uses a VAD module to check for human speech interference. If speech is present, the system informs the user that speech is present and, in turn, will wait until the speech is no longer present or the timeout is exceeded, at block 908. As described in regard to method 800, in alternative methods the VAD module (blocks 906 and 908) is not utilized. Instead, a human technician ensures no speaking is present during optimization process. At block 910, when no speech is present, the system will then determine the room noise is low, medium, high, or extreme (these relative ranges can be set as desired).

If the system determines the room noise is low, at block 912A, RT60 is used in this example. RT refers to the reverberance time. RT60 is reverberance time 60. It is a measure used to qualify how reverberant the room is, and by that qualify an important property of the acoustics of a space. If the room noise is medium, at block 912B, the system uses RT30. If the room noise is high, the system uses RT20. If the system determines the room noise is extreme, at block 912D, the room reverberation measurement status is updated. At block 914, the system will then saturate the room with noise using loudspeakers positioned therein. At block 916, the system utilizes a response analyzer to measure the decay. Here, method 600 may be used to inform the measurement of decay, including the measured speech level to confirm accounting for the estimated speech level. Reverberation in the room will be classified as noise and the non-noise will be removed (i.e., the estimated speech levels).

In certain embodiments, video analysis of the room (e.g., using cameras 160) may be used to visually identify acoustically reflective surfaces (e.g., glass walls, hard floors). This data can be used by the system to support or validate measured RT60 values and guide optimization recommendations.

At block 918, the system then records or extrapolates the RT60. To calculate the RT60, in certain embodiments, either a literal 60 dB decay can be measured in the acoustic environment, or a 30 dB/20 dB/15 dB/etc. (RT30/RT20/RT15/etc.) can be measured and converted to an RT60 by directly multiplying the time measured to extrapolate from 30 or 20 or 15, etc. to 60, or some other suitable method to model some amount of the non-linearity that might occur in the dB decay for smaller amounts vs. larger. At block 920, the system then updates the room reverberation measurement status accordingly.

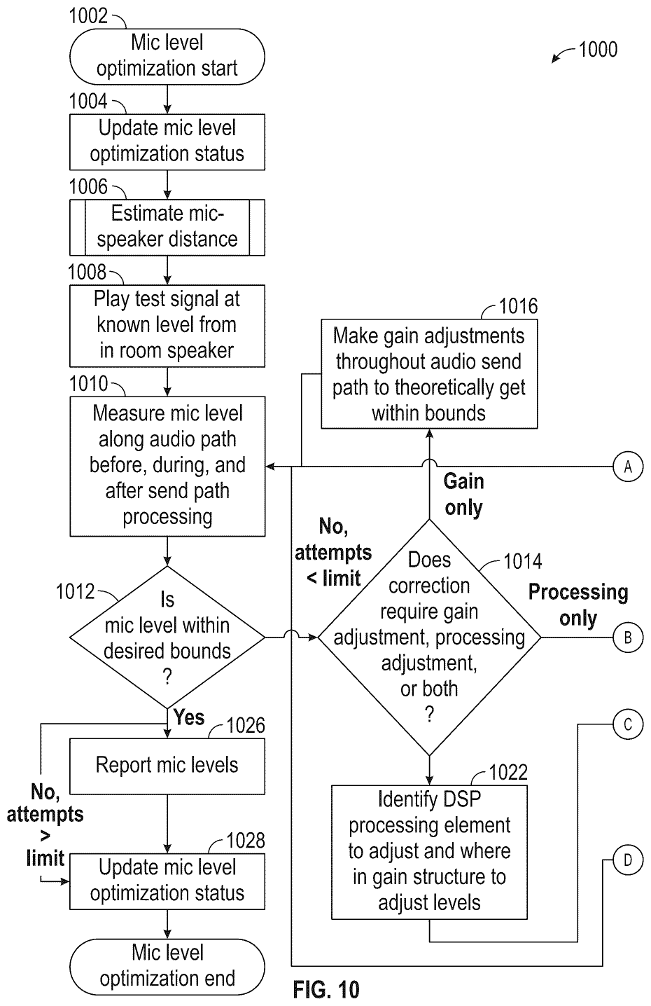

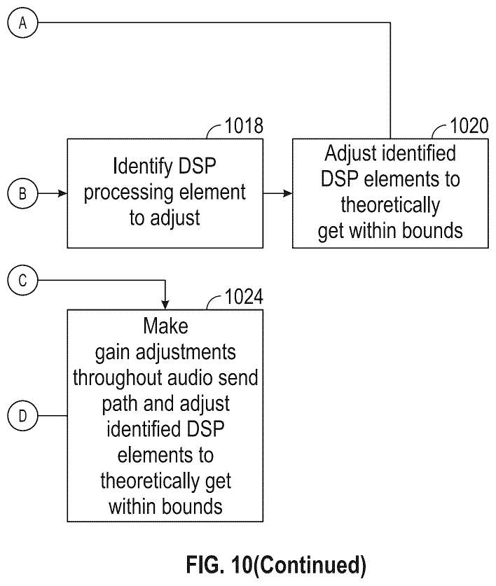

The audio optimization methods described herein may also be used to optimize microphone levels. FIG. 10 is a flow chart of a method to optimize a microphone level using, for example, the method 600. At block 1002 of method 1000, the system boots up and updates the microphone level optimization status, at block 1004, as previously described herein. Further, at block 1004, the system determines if any interfering speech is present using, for example, the method 600. This block, as a subprocess, will call other algorithms to obtain a quality test signal. Such algorithms include signal detection and qualification, source separation and biometrics, as described in, for example, FIG. 2. The outputs of the subprocess will be used to determine whether there is interfering speech or signals. If so, the system will return to checking for a usable test signal. If the system determines there is not a usable test signal (e.g., after a timeout), the system will indicate a failure because of interference and update the status accordingly.

Once a usable test signal is obtained (at block 1004), the system will determine the microphone speaker distance, at block 1006. This is achieved by, for example, use of a known signal played at a known level from a speaker with a known sensitivity and measured at a mic with a known sensitivity. Since all values internal to the system are known, the only significant unknown is the level decay due to distance. This level decay can be related to distance through the inverse square law of mathematics that is commonly applied in acoustics measurements. At block 1008, the system causes a test signal to play at a known level through the loudspeaker(s) in the room environment. At block 1010, the system measures the microphone level along the audio path before, during, and after the test signal is played. Here, the send path is the audio path (gains and processing elements) leading from and through the microphone and out to the point where it exits the system, usually to be sent to the softphone or USB output for audio calls through Teams/Zoom/Meet/etc. Thus, the send path=the microphone path for all relevant purposes in this process. Alternatively, the system may insert short, non-intrusive test signals (e.g., entry/exit chimes) during transitional moments in meetings. As a result, the system reduces user disruption while enabled real-time optimization.

At block 1012, the system determines whether the microphone level is within a desired bound. If the answer is “No,” the system then determines if the correction of microphone level requires a gain adjustment, processing adjustment, or both, at block 1014. This process will be performed until the “no” attempts exceed a defined limit. For example, for the mic level optimization, an adjustment will come in the form of modifying a gain, level, trim, mute, or any other control in the system that affects the level of the microphones throughout its audio path. Other processing adjustments may include changes to the gate depth, the compressor threshold, or the automixer's number of open microphones control limit. If the system determines only a gain adjustment is necessary, the system will make the necessary gain adjustment throughout the audio path to get the microphone level back within bounds, at block 1016. Thereafter, the algorithm loops back to block 1010. If the system determines only a processing adjustment is necessary, the system will identify the DSP processing element needed to be adjusted, at block 1018, and adjust that DSP element to get the microphone level back within a desired bound, at block 1020. Thereafter, the algorithm loops back to block 1010.

If the system determines both gain and processing adjustments need to be made, the system identifies the DSP processing element to get the gain structure to adjust to the necessary microphone level, at block 1022. The system may further make the gain adjustments throughout the audio path and adjust the DSP elements as necessary, at block 1024. Thereafter, the algorithm loops back to block 1010.

At block 1012, if the system determines the microphone level is within the desired bound, the system reports the microphone levels at block 1026. Thereafter, at block 1028, the system updates the microphone level optimization status and performs those same processes discussed in relation to block 1004. Note, also, if the number of “no” attempts (at block 1012) exceeds a defined limit, the algorithm loops to block 1028. Accordingly, the microphone level optimization process comes to an end.

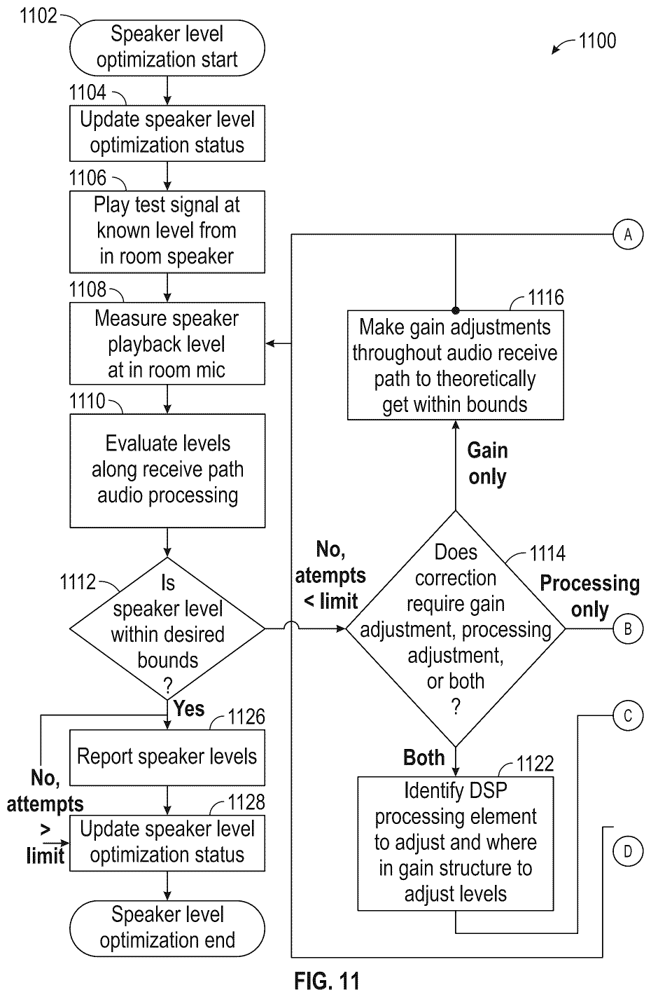

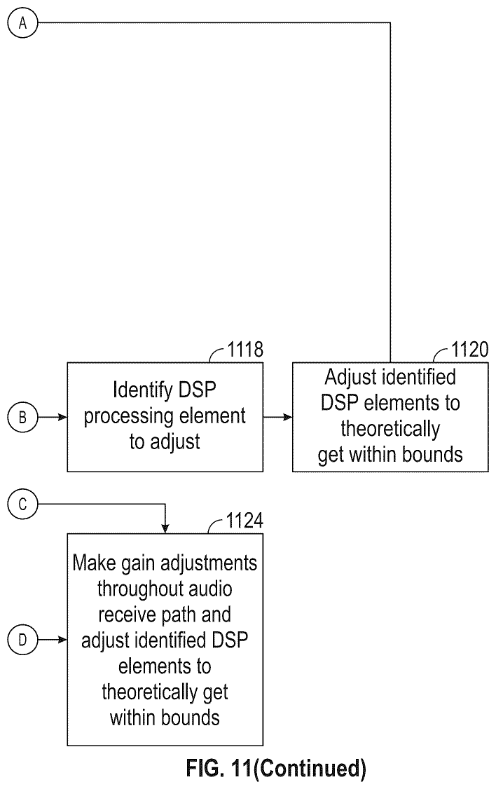

The audio optimization methods described herein may also be used to optimize speaker levels. FIG. 11 is a flow chart of a method to optimize a speaker level using, for example, the method 600. At block 1102 of method 1100, the system may boot up and update the speaker level optimization status, at block 1104. Further, at block 1104, the system determines if any interfering speech is present using, for example, the method 600. This block, as a subprocess, will call other algorithms to obtain a quality test signal. Such algorithms include signal detection and qualification, source separation and biometrics, as described in, for example, FIG. 2. The outputs of the subprocess will be used to determine whether there is interfering speech or signals. If so, the system will return to checking for a usable test signal. If the system determines there is a no usable test signal (e.g., after a timeout), the system will indicate a failure because of interference and update the status accordingly.

At block 1106, the system causes a test signal to play at a known level through the loudspeaker(s) in the room environment. At block 1108, the system measures the speaker playback level at the room microphones(s). At block 1110, the system evaluates the audio levels along the received path. The receive path is the audio path up to and through the loudspeakers. This audio often originates from the softphone or USB audio from Teams/Zoom/etc. call. At block 1112, the system determines whether the speaker level is within a desired bound. If the answer is “No,” the system then determines if the correction of speaker level requires a gain adjustment, processing adjustment or both, at block 1114. This process will be performed until the “no” attempts exceed a defined limit. If the system determines only a gain adjustment is necessary, the system will make the necessary gain adjustment throughout the audio path to get the speaker level back within bounds, at block 1116. Thereafter, the algorithm loops back to block 1108. If the system determines only a processing adjustment is necessary, the system will identify the DSP processing element needed to be adjusted, at block 1118, and adjust that DSP element to get the speaker level back within the desired bound at block 1120. Thereafter, the algorithm loops back to block 1108.

If the system determines both gain and processing adjustments need to be made, the system identifies the DSP processing element to get the gain structure to adjust to the necessary speaker level, at block 1122. Then, the system further makes the gain adjustments throughout the audio path and adjusts the DSP elements as necessary, at block 1124. Thereafter, the algorithm loops back to block 1108.

At block 1112, if the system determines the speaker level is within the desired bound. Here, for example, a desired bound may be within 65-75 dBSPL-A. The system then reports the speaker levels at block 1126. Thereafter, at block 1128, the system updates the speaker level optimization status and performs those same processes discussed in relation to block 1104. Note, also, if the number of “no” attempts (at block 1112) exceeds a defined limit, the algorithm loops to block 1128. Accordingly, the speaker level optimization process comes to an end.

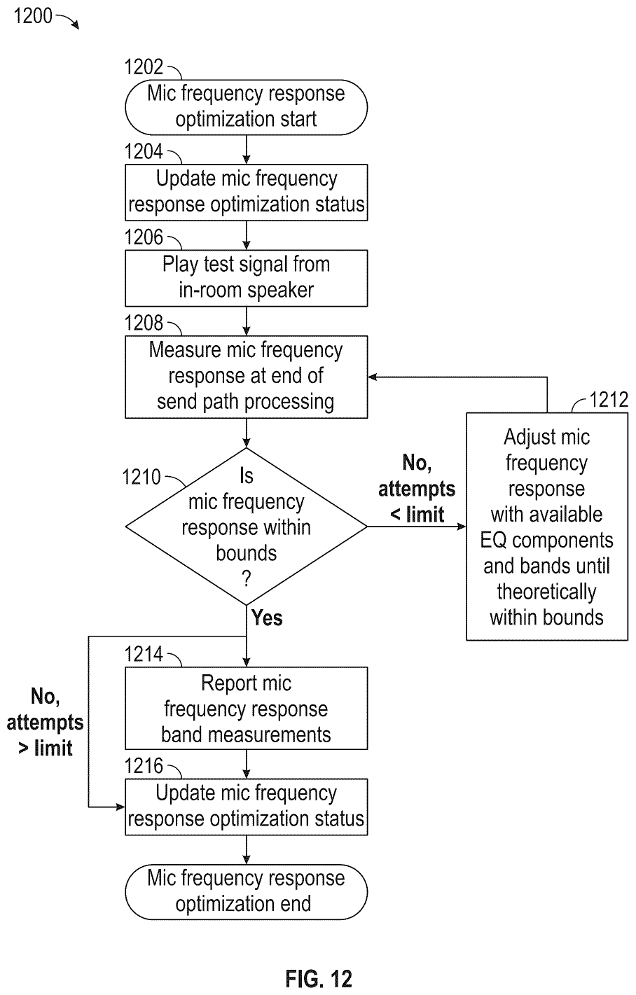

The audio optimization methods described herein may also be used to optimize microphone frequency responses. FIG. 12 is a flow chart of a method to optimize a microphone frequency response using, for example, the method 600. At block 1202 of method 1200, the system boots up and updates the microphone frequency response optimization status, at block 1204. Further, at block 1204, the system determines if any interfering speech is present using, for example, the method 600. This block, as a subprocess, will call other algorithms to obtain a quality test signal. Such algorithms include signal detection and qualification, source separation and biometrics, as described in, for example, FIG. 2. The outputs of the subprocess will be used to determine whether there is interfering speech or signals. If so, the system will return to checking for a usable test signal. If the system ultimately determines there is a no usable test signal (e.g., after a timeout), the system will indicate a failure because of interference and update the status accordingly.

At block 1206, the system causes a test signal to play at a known level through the loudspeaker(s) in the room environment. At block 1208, the system measures the microphone frequency response at the end of the send path processing (send path=mic path). At block 1210, the system determines whether the microphone frequency response is within a desired bound. If the answer is “No,” the system then adjusts the microphone frequency response with available EQ components and bands until within the desired bounds, at block 1212. Thereafter, the algorithm loops back to block 1208.

At block 1210, if the system determines the microphone frequency response is within the desired bound, the system reports the microphone frequency response bands at block 1214. Thereafter, at block 1216, the system updates the microphone frequency response optimization status and performs those same processes discussed in relation to block 1204. Note, also, if the number of “no” attempts (at block 1210) exceeds a defined limit, the algorithm loops to block 1216. Accordingly, the microphone frequency response optimization process comes to an end.

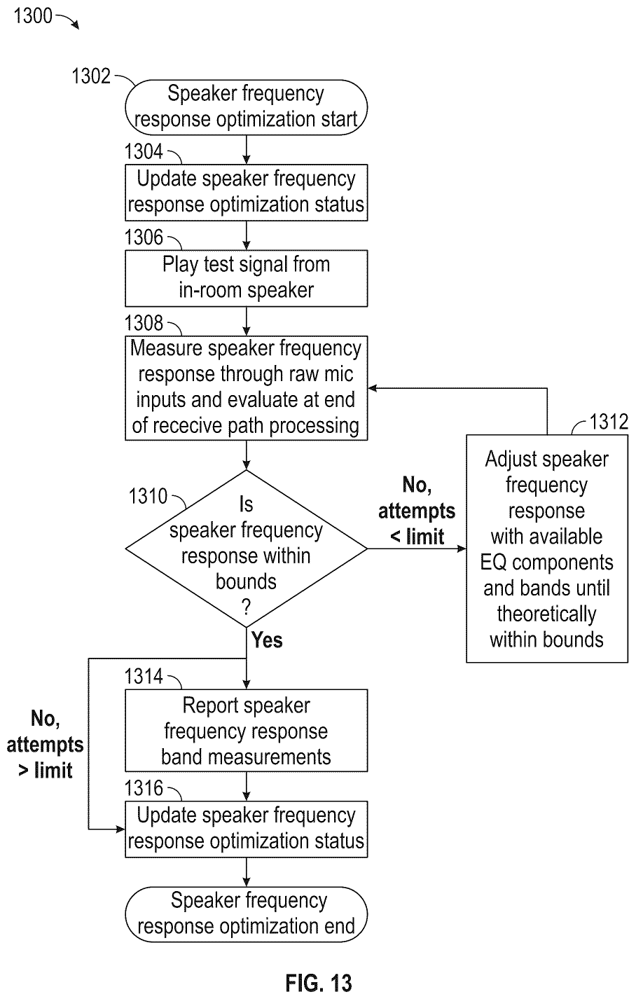

The audio optimization methods described herein may also be used to optimize speaker frequency responses. FIG. 13 is a flow chart of a method to optimize a speaker frequency response using, for example, the method 600. At block 1302 of method 1300, the system boots up and updates the speaker frequency response optimization status, at block 1304. Further, at block 1304, the system determines if any interfering speech is present using, for example, the method 600. This block, as a subprocess, will call other algorithms to obtain a quality test signal. Such algorithms include signal detection and qualification, source separation and biometrics, as described in, for example, FIG. 2. The outputs of the subprocess will be used to determine whether there is interfering speech or signals. If so, the system will return to checking for a usable test signal. If the system determines there is a no usable test signal (e.g., after a timeout), the system will indicate a failure because of interference and update the tatus accordingly.

At block 1306, the system causes a test signal to play at a known level through the loudspeaker(s) in the room environment. At block 1308, the system measures the speaker frequency response through raw microphone inputs at the end of the send path processing (the end of the receive path is the audio signal coming out of the loudspeaker after all processing is complete). At block 1310, the system determines whether the speaker frequency response is within a desired bound. If the answer is “No,” the system then adjusts the speaker frequency response with available EQ components and bands until within the desired bounds such as, for example, a passband of +−6 dB, giving a window of 12 dB, at block 1312. Thereafter, the algorithm loops back to block 1308.

At block 1310, if the system determines the speaker frequency response is within the desired bound, the system reports the microphone frequency response bands at block 1314. Thereafter, at block 1316, the system updates speaker frequency response optimization status and performs those same processes discussed in relation to block 1304. Note, also, if the number of “no” attempts (at block 1310) exceeds a defined limit, the algorithm loops to block 1316. Accordingly, the speaker frequency response optimization process comes to an end.

Note the test signals described herein may take a variety of forms such as, for example, noise, speech, sinusoids, etc. The variety of test signals provides the system with flexibility and robustness.

Accordingly, illustrative embodiments of the present disclosure provide a variety of methods to optimize acoustic characteristics of a room environment. The described systems simplify the commissioning and sustaining efforts to make a room environment operational and usable. At setup time, the ability to measure, optimize and report the state of the room environment and audio system is valuable to give designers, installers and users confidence the system is working well. The system may be run as a scheduled or on-demand room health check, and users can verify the room audio is working well or address the reported issues promptly.

Further, the use of VAD modules provides SNR and power estimation for noise and speech sources. This ability can be used in the described optimization systems to allow the system to continue running noise and reverberation measurements even during interfering speech. Knowing the power level of the speech versus noise allows the system to subtract the undesired signal from the measured signal.

In addition, with signal detection and source separation, microphone and speaker level optimizations can be run even during interfering speech and noises, when those sources are detected, qualified and separated, as described herein. Notably, this allows clearer measurement of noise, tone, and speech sources used by the described systems. Different noise sources identified by the algorithms described herein can be monitored by the system, and the system can use that output to apply different audio processing settings (e.g., gains, EQs, dynamics) to optimize around those settings. For example, if a noise source is detected and qualified as a low frequency HVAC noise, the described systems use that information to apply low cut filters to reduce that noise specifically.

The voice biometric algorithms described herein give the system the ability to make adjustments to the audio path processing (e.g., gains, EQs, dynamics) based on the users of the room identified by the voice biometrics. The described systems can also build biometrics around system performance with its own test signals versus real users, refining its ability to optimize. Furthermore, the illustrative described systems will monitor the results of the artificial intelligence-based noise reduction algorithms and, if noise reduction is already set dynamically by the algorithm, the system does not need to set it; instead, the system will report the increased noise reduction performance. However, if the noise reduction algorithm is not enabled, the system will continue to set the noise reduction value.

Further, the optimization techniques described herein can be activated by the push of one button on the system console or other user interface. The system can perform optimization without any technicians in the room (scheduled run times). Also, the optimization process can be activated via the system user interface, web or cloud-based access.

These and other advantages will be readily apparent to those ordinarily skilled in the art having the benefit of this disclosure.

Methods and embodiments described herein further relate to any one or more of the following paragraphs:

1. A computer-implemented method to optimize audio system characteristics in a meeting room environment, comprising: implementing an audio optimization and control (“AOC”) operating system on a processing device communicably coupled to at least one microphone and at least one speaker located within the meeting room, the processing device being configured to optimize and control audio functionality of the microphone and speaker; detecting, using the microphone, one or more audio signals from the meeting room; determining, using a Voice Activity Detector (“VAD”) communicably coupled to the processing device, whether speech is present in the audio signals; if it is determined no speech is present in the audio signals, determining the acoustical characteristics of the audio signals; and optimizing, based on the acoustical characteristics of the audio signals, audio system characteristics of the meeting room environment.
2. The computer-implemented method as defined in paragraph 1, wherein determining the audio system characteristics of the audio signals comprises performing at least one of a room noise measurement or room reverberation measurement.
3. The computer-implemented method as defined in paragraphs 1 or 2, wherein optimizing the audio system characteristics of at meeting room environment comprises performing at least one of a microphone level optimization, speaker level optimization, microphone frequency response optimization or speaker frequency response optimization.
4. The computer-implemented method as defined in any of paragraphs 1-3, further comprising generating a report of the audio system characteristics of the meeting room environment, the report comprising at least one of a room health score, room characteristic alert or acoustic-improvement recommendation.
5. The computer-implemented method as defined in in any of paragraphs 1-4, further comprising continuously monitoring, without human intervention, the audio system characteristics of the meeting room environment.
6. The computer-implemented method as defined in in any of paragraphs 1-5, further comprising continuously monitoring, without human intervention, the audio system characteristics of the meeting room environment while a meeting is occurring.
7. The computer-implemented method as defined in in any of paragraphs 1-6, wherein the audio system characteristics of the meeting room environment are optimized based on a scheduled optimization run time.
8. A system, comprising: at least one microphone and at least one speaker located in a meeting room; and a processing device communicably coupled to the microphone and speaker, the processing device having an audio optimization and control (“AOC”) operating system executable thereon to manage and control functionality of the microphone and speaker, the processing core being configured to perform operations as defined in in any of paragraphs 1-7.
9. A computer-implemented method to optimize audio system characteristics in a meeting room environment, comprising: implementing an audio optimization and control (“AOC”) operating system on a processing device communicably coupled to at least one microphone and at least one speaker located within the meeting room, the processing device being configured to optimize and control audio functionality of the microphone and speaker; detecting, using the microphone, one or more audio signals from the meeting room; classifying, using a Voice Activity Detector (“VAD”) communicably coupled to the processing device, the audio signals into one or more audio segments; determining, using the audio segments, a speech signal-to-noise ratio (“SNR”) of the audio signals; and optimizing, based on the speech SNR of the audio signals, audio system characteristics of the meeting room environment.
10. The computer-implemented method as defined in paragraph 9, wherein determining the speech SNR comprises: filtering at least one of a speech segment or noise segment out of the audio segments; if a speech segment is filtered, measuring a noise level of the audio segments; if a noise segment is filtered, determining a speech level of the audio segments; and determining, based upon at least one of the noise or speech level, the speech SNR of the audio segments.
11. The computer-implemented method as defined in paragraph 9 or 10, further comprises performing, using the speech SNR, voice biometrics of the meeting room environment.
12. The computer-implemented method as defined in in any of paragraphs 9-11, wherein voice biometrics comprises at least one of scanning, selecting or mapping speech sources.
13. The computer-implemented method as defined in in any of paragraphs 9-12, further comprising generating a report of the audio system characteristics of the meeting room environment, the report comprising at least one of a room health score, room characteristic alert or acoustic-improvement recommendation.
14. The computer-implemented method as defined in in any of paragraphs 9-13, further comprising continuously monitoring, without human intervention, the audio system characteristics of the meeting room environment.
15. The computer-implemented method as defined in in any of paragraphs 9-14, further comprising continuously monitoring, without human intervention, the audio system characteristics of the meeting room environment while a meeting is occurring.
16. The computer-implemented method as defined in in any of paragraphs 9-15, wherein the audio segments are classified into a speech-only segment, noise-only segment or speech-with-noise segment classification.
17. The computer-implemented method as defined in in any of paragraphs 9-16, wherein echo cancellation is applied to the detected audio signals before the audio signals are classified by the VAD.
18. The computer-implemented method as defined in in any of paragraphs 9-17, wherein the audio system characteristics of the meeting room environment are optimized based on a scheduled optimization run time.
19. The computer-implemented method as defined in in any of paragraphs 9-18, wherein optimizing the audio system characteristics of the meeting room environment comprises optimizing: overall microphone conferencing level within a band of acceptability; overall speaker playback level within a band of acceptability; overall microphone conferencing frequency response with a band of acceptability; or overall speaker playback frequency response within a band of acceptability.
20. A system, comprising: at least one microphone and at least one speaker located in a meeting room; and a processing device communicably coupled to the microphone and speaker, the processing device having an audio optimization and control (“AOC”) operating system executable thereon to manage and control functionality of the microphone and speaker, the processing core being configured to perform operations as defined in in any of paragraphs 9-19.

Moreover, the methods described herein may be embodied within a system comprising processing circuitry to implement any of the methods, or a in a non-transitory computer-readable medium comprising instructions which, when executed by at least one processor, causes the processor to perform any of the methods described herein.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

What is claimed is:

1. A computer-implemented method to optimize audio system characteristics in a meeting room environment, comprising:
implementing an audio optimization and control (“AOC”) operating system on a processing device communicably coupled to at least one microphone and at least one speaker located within the meeting room, the processing device being configured to optimize and control audio functionality of the microphone and speaker;
detecting, using the microphone, one or more audio signals from the meeting room;
determining, using a Voice Activity Detector (“VAD”) communicably coupled to the processing device, whether speech is present in the audio signals;
if it is determined no speech is present in the audio signals, determining the acoustical characteristics of the audio signals; and
optimizing, based on the acoustical characteristics of the audio signals, audio system characteristics in the meeting room environment.

2. The computer-implemented method as defined in claim 1, wherein determining the acoustical characteristics of the audio signals comprises performing at least one of a room noise measurement or room reverberation measurement.

3. The computer-implemented method as defined in claim 1, wherein optimizing the audio system characteristics in the meeting room environment comprises performing at least one of a microphone level optimization, speaker level optimization, microphone frequency response optimization, or speaker frequency response optimization.

4. The computer-implemented method as defined in claim 1, further comprising generating a report of the audio system characteristics in the meeting room environment, the report comprising at least one of a room health score, room characteristic alert, or acoustic-improvement recommendation.

5. The computer-implemented method as defined in claim 1, further comprising continuously monitoring, without human intervention, the audio system characteristics in the meeting room environment.

6. The computer-implemented method as defined in claim 1, further comprising continuously monitoring, without human intervention, the audio system characteristics in the meeting room environment while a meeting is occurring.

7. The computer-implemented method as defined in claim 1, wherein the audio system characteristics in the meeting room environment are optimized based on a scheduled optimization run time.

8. A system, comprising:
at least one microphone and at least one speaker located in a meeting room; and
a processing device communicably coupled to the microphone and speaker, the processing device having an audio optimization and control (“AOC”) operating system executable thereon to manage and control functionality of the microphone and speaker, the processing core being configured to perform operations as defined in claim 1.

9. A computer-implemented method to optimize audio system characteristics in a meeting room environment, comprising:
implementing an audio optimization and control (“AOC”) operating system on a processing device communicably coupled to at least one microphone and at least one speaker located within the meeting room, the processing device being configured to optimize and control audio functionality of the microphone and speaker;
detecting, using the microphone, one or more audio signals from the meeting room;
classifying, using a Voice Activity Detector (“VAD”) communicably coupled to the processing device, the audio signals into one or more audio segments;
determining, using the audio segments, a speech signal-to-noise ratio (“SNR”) of the audio signals; and
optimizing, based on the speech SNR of the audio signals, audio system characteristics of the meeting room environment.

10. The computer-implemented method as defined in claim 9, wherein determining the speech SNR comprises:
filtering at least one of a speech segment or noise segment out of the audio segments;
if a speech segment is filtered, measuring a noise level of the audio segments;
if a noise segment is filtered, determining a speech level of the audio segments; and
determining, based upon at least one of the noise or speech level, the speech SNR of the audio segments.

11. The computer-implemented method as defined in claim 9, further comprises performing, using the speech SNR, voice biometrics of the meeting room environment.

12. The computer-implemented method as defined in claim 11, wherein voice biometrics comprises at least one of scanning, selecting or mapping speech sources.

13. The computer-implemented method as defined in claim 9, further comprising generating a report of the acoustical characteristics in the meeting room environment, the report comprising at least one of a room health score, room characteristic alert or acoustic-improvement recommendation.

14. The computer-implemented method as defined in claim 9, further comprising continuously monitoring, without human intervention, the audio system characteristics in the meeting room environment.

15. The computer-implemented method as defined in claim 9, further comprising continuously monitoring, without human intervention, the audio system characteristics in the meeting room environment while a meeting is occurring.

16. The computer-implemented method as defined in claim 9, wherein the audio segments are classified into a speech-only segment, noise-only segment or speech-with-noise segment classification.

17. The computer-implemented method as defined in claim 9, wherein echo cancellation is applied to the detected audio signals before the audio signals are classified by the VAD.

18. The computer-implemented method as defined in claim 9, wherein the audio system characteristics in the meeting room environment are optimized based on a scheduled optimization run time.

19. The computer-implemented method as defined in claim 9, wherein optimizing the audio system characteristics in the meeting room environment comprises optimizing:
overall microphone conferencing level within a band of acceptability;
overall speaker playback level within a band of acceptability;
overall microphone conferencing frequency response with a band of acceptability; or
overall speaker playback frequency response within a band of acceptability.

20. A system, comprising:
at least one microphone and at least one speaker located in a meeting room; and
a processing device communicably coupled to the microphone and speaker, the processing device having an audio optimization and control (“AOC”) operating system executable thereon to manage and control functionality of the microphone and speaker, the processing core being configured to perform operations as defined in claim 9.

21. A non-transitory computer-readable storage medium storing instructions that, when executed by a computing system, cause the computing system to perform operations as defined in claim 1 or 9.
